(19) United States
(12) Patent Application Publication
(10) Pub. No.: US 2025/0016472 A1
(43) Pub. Date: Jan. 9, 2025

(54) SIGNAL PROCESSING DEVICE, SIGNAL PROCESSING METHOD, AND SOLID-STATE IMAGE SENSOR

(71) Applicant: SONY SEMICONDUCTOR SOLUTIONS CORPORATION, KANAGAWA (JP)

(72) Inventor: SEIGO HANADA, KANAGAWA (JP)

(21) Appl. No.: 18/711,645

(22) PCT Filed: Nov. 15, 2022
(86) PCT No.: PCT/JP2022/042321

§ 371 Date: May 20, 2024

(30) Foreign Application Priority Data
Nov. 29, 2021 (JP) 2021-193434

(51) Int. Cl. H04N 25/77; G06F 7/544; G06F 17/15

(52) U.S. Cl. CPC H04N 25/77; G06F 7/5443; G06F 17/15

(57) ABSTRACT

The present disclosure relates to a signal processing device, a signal processing method, and a solid-state image sensor capable of further improving signal processing capability. A signal processing device includes: a product-sum operation processing unit that includes first arithmetic units of a number corresponding to the number of channels, and performs product-sum operation processing of an input pixel value, which is pixel data of an input image, and a filter coefficient in each of the first arithmetic units to acquire product-sum operation results corresponding to the number of channels; and a convolution operation processing unit including second arithmetic units of a number corresponding to the number of filters, and performing convolution operation processing of acquiring convolution layer output pixel values corresponding to the number of filters by performing convolution operation processing using the product-sum operation result in each of the second arithmetic units and outputting the convolution layer output pixel values as encoded pixel data. The present technology can be applied to, for example, a stacked CMOS image sensor.

### TECHNICAL FIELD

The present disclosure relates to a signal processing device, a signal processing method, and a solid-state image sensor, and more particularly, to a signal processing device, a signal processing method, and a solid-state image sensor capable of further improving signal processing capability.

### BACKGROUND ART

In recent years, a solid-state image sensor such as a complementary metal oxide semiconductor (CMOS) image sensor has become highly functional, and for example, it is possible to perform a convolution operation on pixel data of a captured image and output encoded pixel data.

For example, Patent Document 1 discloses a technique of extracting image data in a plurality of convolution windows in parallel by a plurality of data processing units during a process of extracting convolution data.

### CITATION LIST

### Patent Document

Patent Document 1: Japanese Patent Application Laid-Open No. 2021-22362

### SUMMARY OF THE INVENTION

### Problems to be Solved by the Invention

By the way, in the signal processing for performing the convolution operation as described above, further improvement in signal processing capability is required.

The present disclosure has been made in view of such a situation, and an object thereof is to further improve signal processing capability.

### Solutions to Problems

A signal processing device according to an aspect of the present disclosure includes: a product-sum operation processing unit that includes first arithmetic units of a number corresponding to the number of channels, and performs product-sum operation processing of an input pixel value, which is pixel data of an input image, and a filter coefficient in each of the first arithmetic units to acquire product-sum operation results corresponding to the number of channels; and a convolution operation processing unit including second arithmetic units of a number corresponding to the number of filters, and performing convolution operation processing of acquiring convolution layer output pixel values corresponding to the number of filters by performing convolution operation processing using the product-sum operation result in each of the second arithmetic units and outputting the convolution layer output pixel values as encoded pixel data.

A signal processing method according to an aspect of the present disclosure, causes a signal processing device including a product-sum operation processing unit including first arithmetic units of a number corresponding to the number of channels and a convolution operation processing unit including second arithmetic units of a number corresponding to the number of filters to perform the steps of: acquiring product-sum operation results corresponding to the number of channels by performing a product-sum operation processing of an input pixel value, which is pixel data of an input image, and a filter coefficient in each of the first arithmetic units; and performing convolution operation processing of acquiring convolution layer output pixel values corresponding to the number of filters by performing convolution operation processing using the product-sum operation result in each of the second arithmetic units, and outputting the convolution layer output pixel values as encoded pixel data.

A solid-state image sensor according to an aspect of the present disclosure includes: a signal processing unit including: a product-sum operation processing unit that includes first arithmetic units of a number corresponding to the number of channels, and performs product-sum operation processing of an input pixel value, which is pixel data of an input image, and a filter coefficient in each of the first arithmetic units to acquire product-sum operation results corresponding to the number of channels; and a convolution operation processing unit including second arithmetic units of a number corresponding to the number of filters, and performing convolution operation processing of acquiring convolution layer output pixel values corresponding to the number of filters by performing convolution operation processing using the product-sum operation result in each of the second arithmetic units and outputting the convolution layer output pixel values as encoded pixel data.

In one aspect of the present disclosure, a product-sum operation result corresponding to the number of channels is acquired by performing product-sum operation processing of an input pixel value, which is pixel data of an input image, and a filter coefficient in each of the first arithmetic units of a number corresponding to the number of channels, and convolution operation processing of acquiring convolution layer output pixel values corresponding to the number of filters by performing convolution operation processing using the product-sum operation result in each of the second arithmetic units of a number corresponding to the number of filters and outputting the convolution layer output pixel value as encoded pixel data is performed.

### BRIEF DESCRIPTION OF DRAWINGS

FIG. 1 is a block diagram illustrating a configuration example of an image sensor according to an embodiment of the present technology.

FIG. 2 is a diagram illustrating processing on a pixel signal.

FIG. 3 is a block diagram illustrating a configuration example of a storage unit and an encoding unit.

FIG. 4 is a block diagram illustrating one configuration example of an arithmetic unit.

FIG. 5 is a block diagram illustrating another configuration example of an arithmetic unit.

FIG. 6 is a diagram illustrating parallel product-sum operation.

FIG. 7 is a diagram illustrating an example of an arithmetic expression used in a convolution operation.

FIG. 8 is a diagram illustrating convolution operation processing performed using three filters.

FIG. 9 is a diagram illustrating first operation processing.

FIG. 10 is a diagram illustrating second operation processing.

FIG. 11 is a diagram illustrating an input image transfer method.

FIG. 12 is a flowchart illustrating a first processing example of convolution operation processing.

FIG. 13 is a flowchart illustrating a second processing example of the convolution operation processing.

FIG. 14 illustrates a configuration example of a stacked image sensor.

FIG. 15 is a block diagram illustrating a configuration example of an imaging device.

FIG. 16 is a diagram illustrating a usage example of using an image sensor.

### MODE FOR CARRYING OUT THE INVENTION

Hereinafter, specific embodiments to which the present technology is applied will be described in detail with reference to the drawings.

### Configuration Example of Image Sensor

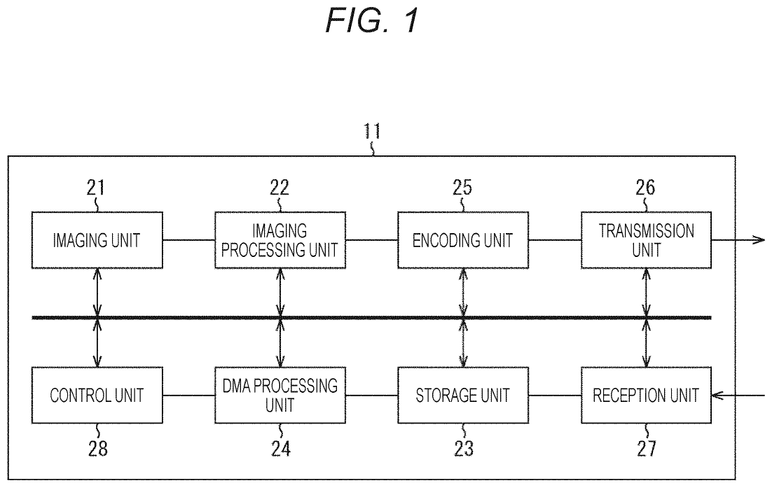

FIG. 1 is a block diagram depicting a configuration example of an embodiment of a solid-state image sensor to which the present technology is applied.

As illustrated in FIG. 1, an image sensor 11 is configured by connecting an imaging unit 21, an imaging processing unit 22, a storage unit 23, a DMA processing unit 24, an encoding unit 25, a transmission unit 26, a reception unit 27, and a control unit 28 through a bus.

The imaging unit 21 includes a plurality of pixels arranged in a matrix on a sensor surface, and supplies a pixel signal corresponding to the amount of light received by each pixel to the imaging processing unit 22.

The imaging processing unit 22 performs, for example, imaging processing such as demosaic processing on the pixel signal supplied from the imaging unit 21, and supplies pixel data obtained as a result of the imaging processing to the storage unit 23.

The storage unit 23 includes, for example, a dynamic random access memory (DRAM) or the like, and stores pixel data supplied from the imaging processing unit 22.

A direct memory access (DMA) processing unit 24 executes processing related to memory access when pixel data is directly transferred from the storage unit 23 to the encoding unit 25.

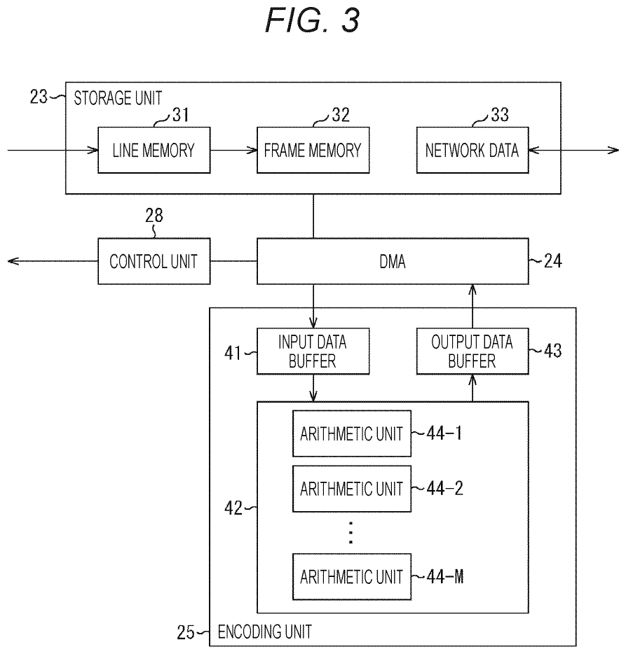

The encoding unit 25 encodes the image captured by the imaging unit 21 by performing convolution operation processing on the pixel data transferred from the storage unit 23 according to the memory access by the DMA processing unit 24. Then, the encoding unit 25 stores the encoded pixel data in the storage unit 23. Note that a detailed configuration of the encoding unit 25 will be described later with reference to FIG. 3.

The transmission unit 26 reads the encoded pixel data from the storage unit 23 and transmits the pixel data to an outside of the image sensor 11 (for example, a recording medium, a display unit, or the like).

The reception unit 27 receives, for example, control data and the like transmitted from a control device (not illustrated), and supplies the control data and the like to the control unit 28.

The control unit 28 controls each block configuring the image sensor 11 according to the control data, and executes imaging by the image sensor 11.

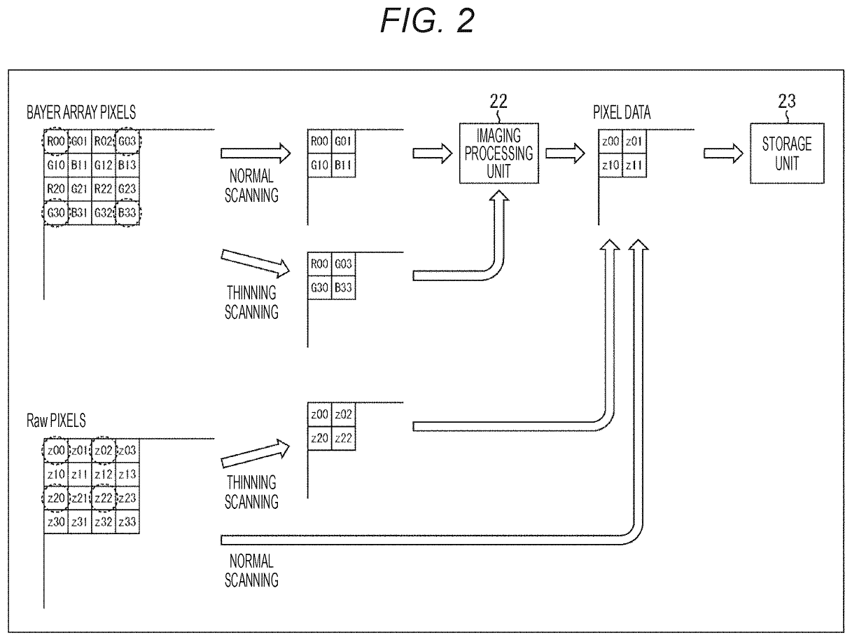

FIG. 2 is a diagram illustrating processing on a pixel signal output from the imaging unit 21.

For example, the imaging unit 21 can adopt a configuration including Bayer array pixels or a configuration including Raw pixels, and can output a pixel signal by normal scanning or thinning scanning in each configuration.

The imaging unit 21 of the Bayer array pixels is configured such that an arrangement pattern in which a color filter of red R is arranged in an upper left pixel, a color filter of green G is arranged in an upper right pixel, a color filter of green G is arranged in a lower left pixel, and a color filter of blue B is arranged in a lower right pixel for four pixels of the 2×2 array is repeated in a row direction and a column direction. Then, in the imaging unit 21 of the Bayer array pixel, a pixel signal R, a pixel signal G, and a pixel signal B representing the luminance value of the light in the wavelength area corresponding to each color are output from the pixels.

For example, in a case where the pixel signal is output by the normal scanning in the imaging unit 21 of the Bayer array pixels, the pixel signals are output from all the pixels. Therefore, the pixel signals output from the pixels in the 2×2 array at the upper left corner output from the imaging unit 21 are a pixel signal R00, a pixel signal G01, a pixel signal G10, and a pixel signal B11.

Furthermore, in a case where a pixel signal is output by thinning scanning in the imaging unit 21 of the Bayer array pixels, as illustrated in the drawing, some pixels marked with dashed circles are selected, and pixel signals are output from these pixels. Therefore, the pixel signals output from the pixels in the 2×2 array at the upper left corner output from the imaging unit 21 are a pixel signal R00, a pixel signal G03, a pixel signal G30, and a pixel signal B33. Note that, in a case where pixel signals are output by thinning scanning, pixel addition of pixels that are not selection targets may be performed, and the pixel signals subjected to pixel addition may be output.

Then, the pixel signal output from the imaging unit 21 of the Bayer array pixel is subjected to demosaic processing in the imaging processing unit 22, for example, and pixel data z acquired by the processing is stored in the storage unit 23.

On the other hand, the imaging unit 21 of the Raw pixel is configured without a color filter such as the Bayer array pixel, and a pixel signal z indicating luminance values of light in all wavelength areas is output from the pixel.

For example, in a case where the pixel signal is output in the normal scanning in the imaging unit 21 of the Raw pixel, the pixel signals are output from all the pixels. Therefore, the pixel signals of 2×2 pixels in the upper left corner output from the imaging unit 21 are a pixel signal z00, a pixel signal z01, a pixel signal z10, and a pixel signal z11. These pixel signals z are used as pixel data z without being processed in the imaging processing unit 22.

Furthermore, in a case where a pixel signal is output by thinning scanning in the imaging unit 21 of the Raw pixels, as illustrated in the drawing, some pixels marked with dashed circles are selected, and pixel signals are output from these pixels. Therefore, the pixel signals of 2×2 pixels in the upper left corner output from the imaging unit 21 are a pixel signal z00, a pixel signal z02, a pixel signal z20, and a pixel signal z22. These pixel signals z are used as pixel data z without being processed in the imaging processing unit 22. Note that the thinned image can also be restored to an original resolution at the time of decoding.

FIG. 3 is a block diagram illustrating a configuration example of the storage unit 23 and the encoding unit 25.

The storage unit 23 includes a line memory 31, a frame memory 32, and a network data memory 33.

The line memory 31 stores the pixel data supplied from the imaging processing unit 22 for each line of the image. The frame memory 32 stores the pixel data for each line supplied from the line memory 31 and stores the pixel data for one frame. The network data memory 33 stores, for example, encoded pixel data output from the encoding unit 25.

The encoding unit 25 includes an input data buffer 41, a convolution operation processing unit 42, and an output data buffer 43.

The input data buffer 41 temporarily stores the pixel data transferred from the frame memory 32 of the storage unit 23 according to the memory access by the DMA processing unit 24, and sequentially inputs the pixel data to the convolution operation processing unit 42.

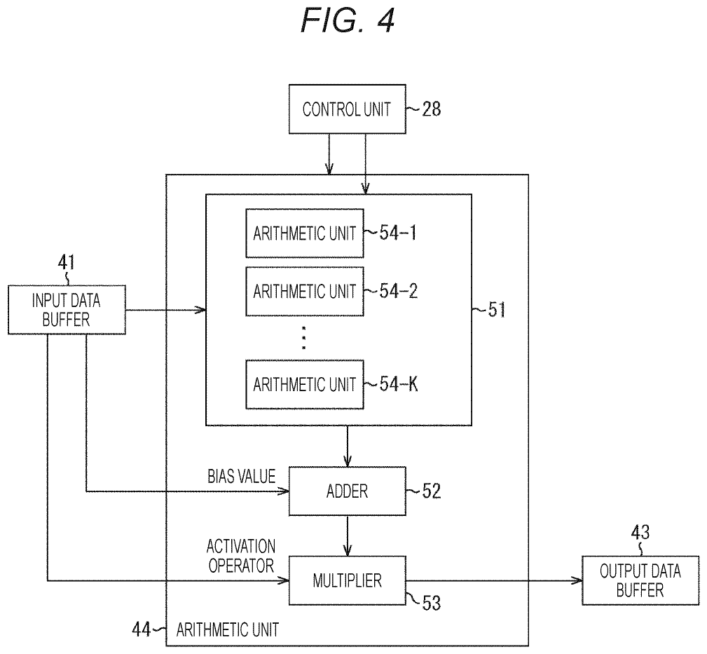

The convolution operation processing unit 42 performs convolution operation processing on the pixel value (hereinafter, referred to as an input pixel value) indicated by the pixel data input through the input data buffer 41. For example, the convolution operation processing unit 42 includes the arithmetic units 44-1 to 44-M as many as the number of filters M, and acquires convolution layer output pixel values corresponding to the number of filters M by performing convolution operation processing on the input pixel values. Then, the convolution operation processing unit 42 outputs the convolution layer output pixel values corresponding to the number of filters M to the output data buffer 43 as encoded pixel data. Note that a detailed configuration of the arithmetic unit 44 will be described later with reference to FIG. 4.

The output data buffer 43 temporarily stores the encoded pixel data supplied from the convolution operation processing unit 42, and sequentially outputs the encoded pixel data to the network data memory 33 of the frame memory 32 according to the memory access by the DMA processing unit 24.

FIG. 4 is a block diagram illustrating a configuration example of the arithmetic unit 44.

The arithmetic unit 44 includes a product-sum operation processing unit 51, an adder 52, and a multiplier 53.

The product-sum operation processing unit 51 performs product-sum operation processing on the input pixel values supplied through the input data buffer 41. For example, the product-sum operation processing unit 51 includes the arithmetic units 54-1 to 54-K as many as the number of channels K, performs product-sum operation processing on the input pixel values to acquire the product-sum operation results for the number of channels K, and supplies the product-sum operation results to the adder 52.

The adder 52 adds the product-sum operation results corresponding to the number of channels K supplied from the product-sum operation processing unit 51, performs an operation of adding the bias value supplied through the input data buffer 41, and supplies a convolution value obtained as a result of the operation to the multiplier 53.

The multiplier 53 performs an activation operation by inputting the convolution value supplied from the adder 52 to an activation operator supplied through the input data buffer 41, and outputs a convolution layer output pixel value obtained as a result of the activation operation to the output data buffer 43.

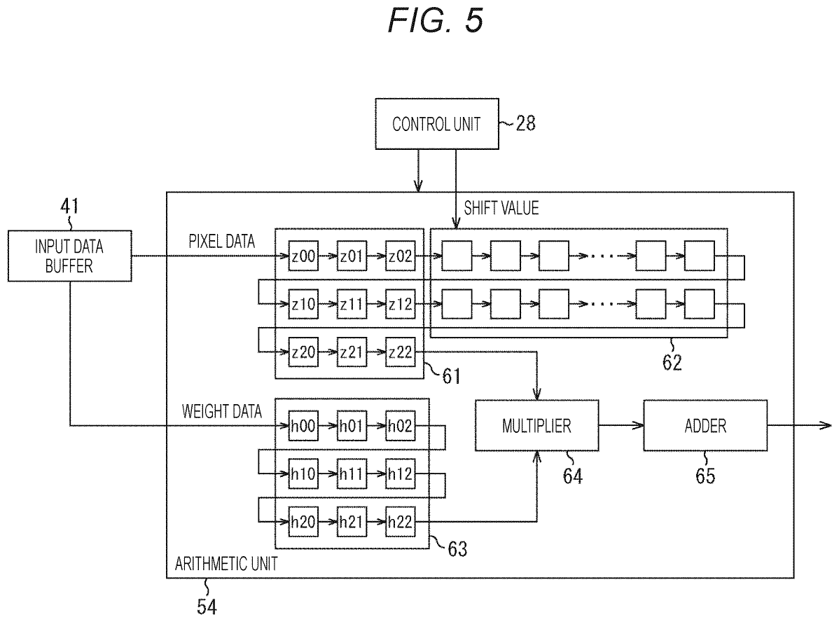

FIG. 5 is a block diagram illustrating a configuration example of the arithmetic unit 54.

The arithmetic unit 54 includes a data buffer 61, a shift register 62, a filter buffer 63, a multiplier 64, and an adder 65.

Pixel data to be an input pixel value z is supplied to the data buffer 61 through the input data buffer 41, and the data buffer 61 sequentially stores the input pixel value z of an array having a size according to the filter size and supplies the input pixel value z to the multiplier 64 as appropriate. In the illustrated example, nine input pixel values z in a 3×3 array are stored in the data buffer 61.

The shift register 62 receives the input pixel values z of the first and second rows stored in the data buffer 61, shifts the input pixel values z by a shift value under the control of the control unit 28, and outputs the input pixel values z to the second and third rows of the data buffer 61, respectively. Note that the illustrated configuration of the shift register 62 is an example, and may be a configuration other than the configuration in which the input pixel values z of the first row and the second row are input.

Weight data to be a filter coefficient h is supplied to the filter buffer 63 through the input data buffer 41, and the filter buffer 63 sequentially stores the filter coefficient h of an array having a size according to the filter size and supplies the filter coefficient h to the multiplier 64 as appropriate. In the illustrated example, nine filter coefficients h in a 3×3 array are stored in the filter buffer 63.

The multiplier 64 performs an operation of multiplying the input pixel value z in the 3×3 array supplied from the data buffer 61 by the filter coefficient h in the 3×3 array supplied from the filter buffer 63, and supplies a multiplication value obtained as a result of the operation to the adder 65.

The adder 65 acquires a product-sum operation result by performing an operation of adding the multiplication values of 3×3 arrays supplied from the multiplier 64, and supplies the product-sum operation result to the adder 52 in FIG. 4.

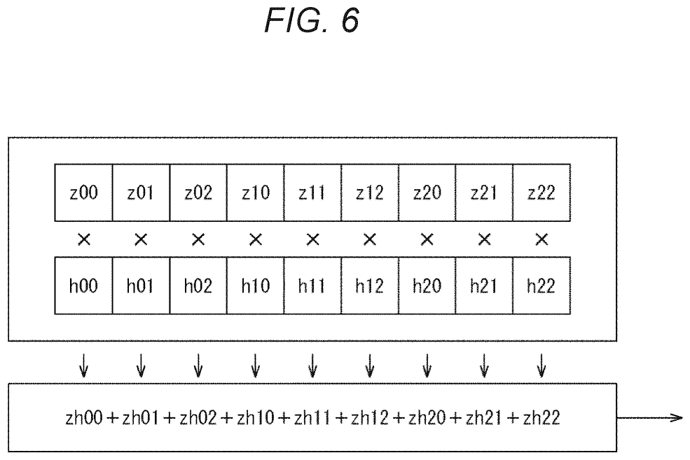

Furthermore, as illustrated in FIG. 6, the multiplier 64 and the adder 65 may perform parallel product-sum operation (vector operation) by rearranging the input pixel value z and the filter coefficient h.

### <Operation of Convolution Layer>

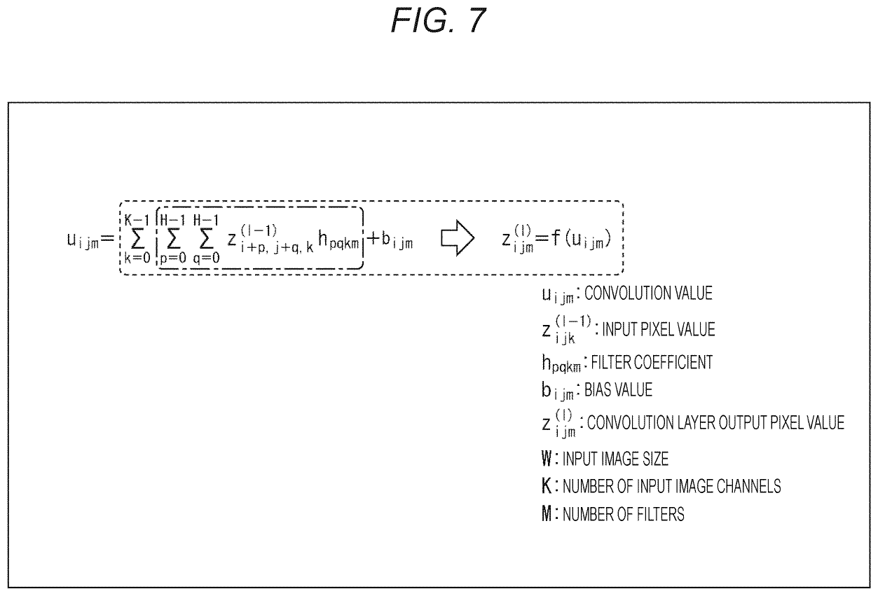

The convolution operation executed in the encoding unit 25 will be described with reference to FIGS. 7 to 10.

FIG. 7 illustrates an example of an arithmetic expression used in the convolution operation.

As illustrated, a convolution value lijm is obtained by performing a product-sum operation on the input pixel value z_{i+p, j+q, k}^{(l-1)} and the filter coefficient h_{pqkm} to obtain a product-sum operation result, and adding the product-sum operation result for the number of channels K of the input image and a bias value bᵢⱼₘ. Then, the convolution layer output pixel value zᵢⱼₘ^{(l)} is obtained by an activation operation performed by inputting the convolution value uᵢⱼₘ to the activation operator f(·).

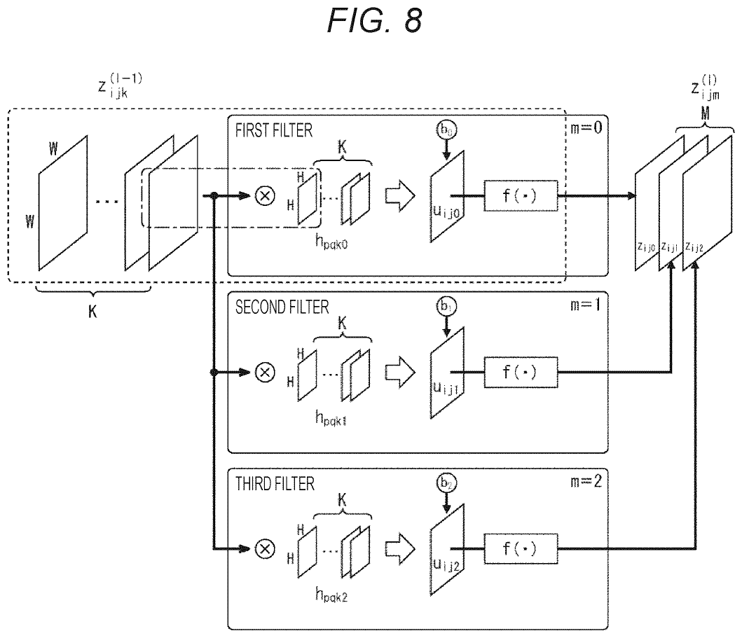

The convolution operation processing in which the image size of the input image is W in the vertical direction×W in the horizontal direction, the input image having the number of channels K is input to each of the arithmetic units 54-1 to 54-K of the encoding unit 25, and the convolution operation processing is performed using three filters (the number of filters M=3) will be described with reference to FIG. 8. Note that the image size of the input image does not need to be the same in height and width.

In a first filter (m=0), the multiplier 64 (FIG. 5) of each arithmetic unit 54 performs an operation of multiplying the input pixel value z_{i+p, j+q, k}^{(l-1)} of the H×H array by the filter coefficient h_{pqk0} of the H×H array. The operation in an area surrounded by a chain line corresponds to the operation in an area surrounded by a chain line in the arithmetic expression of FIG. 7.

Then, in the first filter (m=0), the adder 65 (FIG. 5) of each of the arithmetic units 54 performs an operation of adding the multiplication values in the H×H array obtained as a result of the operation by the multiplier 64, thereby acquiring the product-sum operation result and supplying the product-sum operation result to the adder 52 (FIG. 4). The adder 52 performs an operation of adding the product-sum operation result for the number of channels K and the bias value bᵢⱼ₀ to acquire the convolution value uᵢⱼ₀, and the multiplier 53 inputs the convolution value uᵢⱼ₀ to the activation operator f(·) and performs an activation operation to acquire the convolution layer output pixel value zᵢⱼ₀^{(l)}. The operation in the area surrounded by a broken line corresponds to the operation in the area surrounded by the broken line in the arithmetic expression of FIG. 7.

Furthermore, similarly to the first filter (m=0), a convolution layer output pixel value zᵢⱼ₁^{(l)} and a convolution layer output pixel value zᵢⱼ₂^{(l)} can be acquired also in a second filter (m=1) and a third filter (m=2).

As described above, the convolution operation can be decomposed into the product-sum operation, which is the first operation processing corresponding to a portion surrounded by the chain line, and the sum operation and the activation operation, which are the second operation processing corresponding a portion surrounded by the broken line, for each filter.

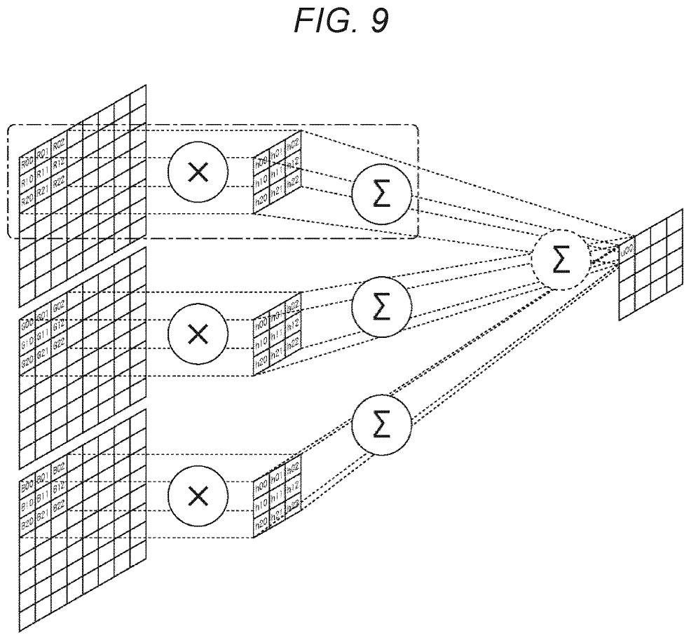

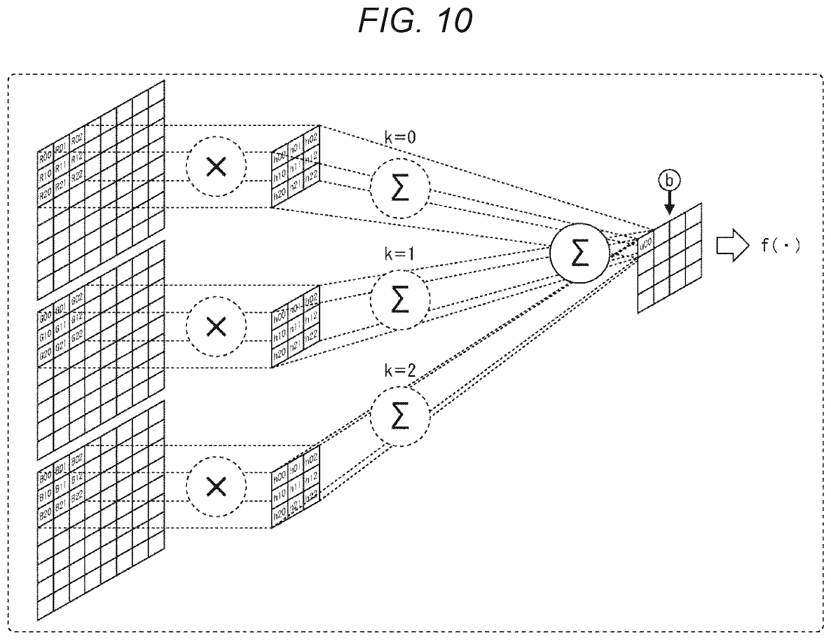

The first operation processing will be described with reference to FIG. 9, and the second operation processing will be described with reference to FIG. 10. In addition, FIGS. 9 and 10 illustrate processing examples in a case where an image of red R, an image of green G, and an image of blue B are used, and the number of channels K is 3.

As illustrated in FIG. 9, for example, the input pixel value of the image of red R is stored in the shift register 62 of the arithmetic unit 54-k (for example, k=0) from the storage unit 23 through the input data buffer 41. Then, the input pixel values (for example, R00, R01, R02, R10, R11, R12, R20, R21, R22) of the 3×3 array of target pixels to be subjected to the filter operation are stored from the shift register 62 into the data buffer 61. In addition, the filter buffer 63 stores filter coefficients (for example, h00, h01, h02, h10, h11, h12, h20, h21, h22) for 3×3 arrays. Then, the multiplier 64 multiplies the input pixel value stored in the data buffer 61 by the filter coefficient stored in the filter buffer 63, and a product-sum operation result obtained by adding the multiplication result by the adder 65 is output.

Similarly, the green G image is input to the arithmetic unit 54-k (for example, k=1), the blue B image is input to the arithmetic unit 54-k (for example, k=2), and the product-sum operation results are output.

As described above, the product-sum operation of performing the filter operation on the target pixel is performed as the first operation processing.

As illustrated in FIG. 10, a product-sum operation result (k=0), a product-sum operation result (k=1), and a product-sum operation result (k=2) output by performing the first operation processing in parallel according to the number of channels are added by the adder 52. Further, the convolution value u is acquired by adding the bias value b by the adder 52, and the multiplier 53 inputs the convolution value u to the activation operator f(·) to perform the activation operation. As a result, the convolution layer output pixel value z^{(l)} is output.

As described above, as the second operation processing, the sum operation of adding the processing results of the first operation processing performed for each channel and the activation operation according to the activation operator f(·) are performed. In addition, the second operation processing is performed in parallel according to the number of filters.

### <Method of Transferring Input Image>

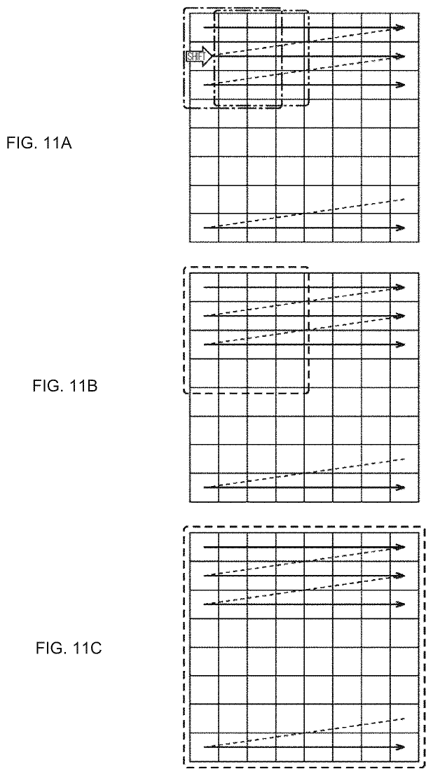

An input image transfer method will be described with reference to FIG. 11.

For example, in the image sensor 11, pixel data of the input image obtained by imaging for each line in the imaging unit 21 is supplied to the storage unit 23 and stored in the frame memory 32 through the line memory 31. Then, the pixel data of the input image is transferred from the frame memory 32 to the input data buffer 41 according to the memory access by the DMA processing unit 24.

A of FIG. 11 is a diagram illustrating a first transfer method (a transfer method not using the shift register 62) of transferring pixel data of an input image according to the number of filter coefficients.

A of FIG. 11 illustrates an example of a case where nine pieces of pixel data, which is the number of filter coefficients, are transferred using the filter size of the 3×3 array and the number of slides is one pixel. For example, nine pieces of pixel data surrounded by a chain line are transferred from the frame memory 32 to the input data buffer 41. Then, the convolution operation processing for the nine pieces of pixel data is completed, and then the nine pieces of pixel data surrounded by a two-dot chain line are transferred from the frame memory 32 to the input data buffer 41 by shifting by one pixel which is the number of slides.

B of FIG. 11 is a diagram illustrating a second transfer method of dividing an input image into a plurality of tiles and transferring pixel data for each of the tiles.

B of FIG. 11 illustrates an example of a case where the input image is divided into four tiles. For example, pixel data surrounded by a broken line is set as one tile, and the pixel data of the tile is transferred from the frame memory 32 to the input data buffer 41. Then, the convolution operation processing for the pixel data of the tile is completed, and then the pixel data of the next tile is transferred from the frame memory 32 to the input data buffer 41 with the next tile as a processing target.

C of FIG. 11 is a diagram illustrating a third transfer method of transferring all the pixel data of the input image.

All pixel data of the input image surrounded by a broken line in C of FIG. 11 is transferred from the frame memory 32 to the input data buffer 41.

### Processing Example of Convolution Operation Processing

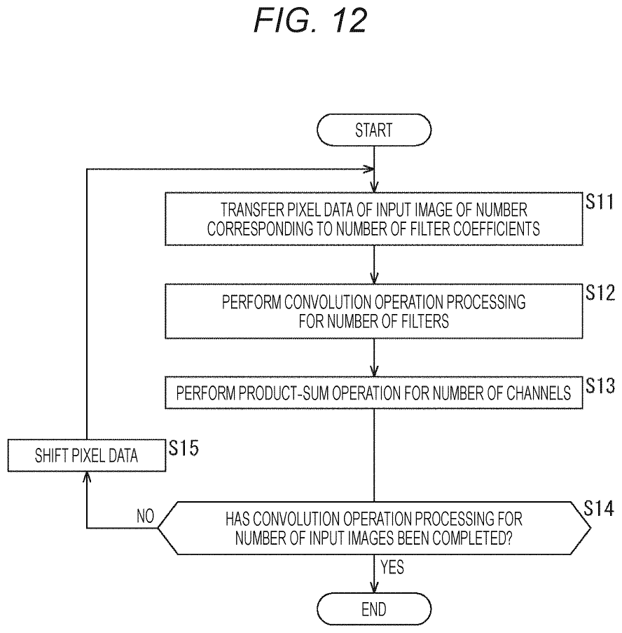

FIG. 12 is a flowchart illustrating a first processing example of the convolution operation processing executed in the encoding unit 25. In the first processing example, as described with reference to A of FIG. 11, the first transfer method of transferring the pixel data of the input image according to the number of filter coefficients is used.

In Step S11, according to the memory access by the DMA processing unit 24, the pixel data of the input image according to the number of filter coefficients is transferred from the frame memory 32 of the storage unit 23 to the input data buffer 41 of the convolution operation processing unit 42.

In Step S12, in the convolution operation processing unit 42, the arithmetic units 44-1 to 44-M as many as the number of filters M perform the convolution operation processing on the pixel data of the input images as many as the number transferred to the input data buffer 41 in Step S11.

In Step S13, in the product-sum operation processing unit 51 of each of the arithmetic units 44-1 to 44-M, the arithmetic units 54-1 to 54-K of the number corresponding to the number of channels K perform the product-sum operation processing of the pixel data of the input images of the number transferred to the input data buffer 41 in Step S11 and the filter coefficients. Note that the product-sum operation processing in Step S13 can be performed as a part of the convolution operation processing in Step S12.

In Step S14, the convolution operation processing unit 42 determines whether or not the convolution operation processing for the input image transferred to the input data buffer 41 in Step S11 has been completed.

In a case where it is determined in Step S14 that the convolution operation processing for the input image has not been completed, the processing proceeds to Step S15.

In Step S15, the DMA processing unit 24 shifts the pixel data to be transferred from the frame memory 32 of the storage unit 23 to the input data buffer 41 of the convolution operation processing unit 42 according to the number of slides. Thereafter, the processing returns to Step S11, the next pixel data is transferred according to the shift, and thereafter, similar processing is repeatedly performed.

On the other hand, in a case where it is determined in Step S14 that the convolution operation processing for the input image has been completed, the convolution operation processing is terminated.

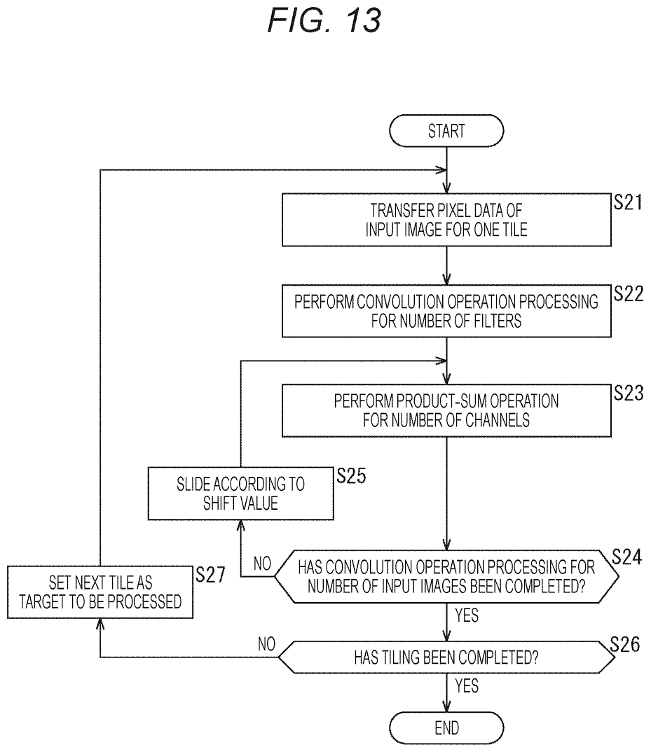

FIG. 13 is a flowchart illustrating a second processing example of the convolution operation processing executed in the encoding unit 25. In the second processing example, as described with reference to B of FIG. 11, the second transfer method of transferring pixel data for each tile is used.

In Step S21, according to the memory access by the DMA processing unit 24, the pixel data of the input image for one tile is transferred from the frame memory 32 of the storage unit 23 to the input data buffer 41 of the convolution operation processing unit 42.

In Step S22, in the convolution operation processing unit 42, the arithmetic units 44-1 to 44-M as many as the number of filters M perform the convolution operation processing on the pixel data of the input image of one tile transferred to the input data buffer 41 in Step S21.

In Step S23, in the product-sum operation processing unit 51 of each of the arithmetic units 44-1 to 44-M, the arithmetic units 54-1 to 54-K as many as the number of channels K perform the product-sum operation processing of the pixel data of the input image for one tile transferred to the input data buffer 41 in Step S21 and the filter coefficient. At this time, as described with reference to FIG. 5, in the arithmetic unit 54, pixel data having a size according to the filter size stored in the data buffer 61 is set as a target of the product-sum operation processing, and the remaining pixel data is held in the shift register 62. Note that the product-sum operation processing in Step S23 can be performed as a part of the convolution operation processing in Step S22.

In Step S24, the arithmetic unit 54 determines whether or not the convolution operation processing for the input image transferred to the input data buffer 41 in Step S11 has been completed.

In a case where it is determined in Step S24 that the convolution operation processing for the input image has not been completed, the processing proceeds to Step S25. In Step S25, the arithmetic unit 54 slides the pixel data held in the shift register 62 according to the shift value under the control of the control unit 28, and sets the pixel data stored in the data buffer 61 after the sliding as a target of the product-sum operation processing. Then, the processing returns to Step S23, and the product-sum operation processing is continuously performed.

On the other hand, in a case where it is determined in Step S24 that the convolution operation processing for the input image has been completed, the processing proceeds to Step S26. In Step S26, the convolution operation processing unit 42 determines whether or not the convolution operation processing for all the tiles has been completed and tiling has been completed.

In a case where it is determined in Step S26 that tiling is not completed, the processing proceeds to Step S27. In Step S27, the DMA processing unit 24 sets the next tile as a processing target for the pixel data transferred from the frame memory 32 of the storage unit 23 to the input data buffer 41 of the convolution operation processing unit 42. Thereafter, the processing returns to Step S11, the pixel data of the next tile is transferred, and thereafter, similar processing is repeatedly performed.

On the other hand, in a case where it is determined in Step S26 that tiling has been completed, the convolution operation processing is terminated.

Note that the convolution operation processing described with reference to FIG. 13 may be applied to the third transfer method of transferring all the pixel data of the input image as described with reference to C of FIG. 11. In this case, the processes of Steps S26 and S27 are omitted, and when it is determined that the convolution operation processing for the input image has been completed in the process of Step S24, the convolution operation processing is terminated.

### Configuration Example of Stacked Image Sensor

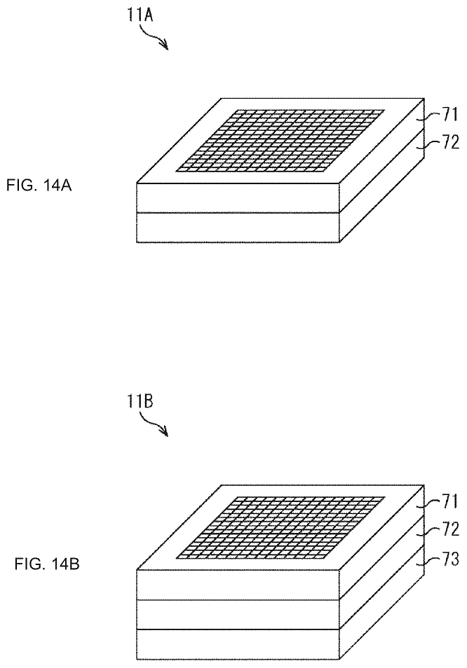

FIG. 14 is a diagram illustrating a configuration example of the stacked-type image sensor 11.

A stacked image sensor 11A illustrated in A of FIG. 14 has a stacked structure in which a sensor substrate 71 provided with an imaging unit 21 in which a plurality of pixels is arranged in a matrix on a sensor surface and a logic substrate 72 provided with an encoding unit 25 and the like are stacked.

A stacked image sensor 11B illustrated in B of FIG. 14 has a stacked structure in which a sensor substrate 71 and a logic substrate 72 are stacked, and a memory substrate 73 provided with a storage unit 23 and the like is stacked, similarly to the stacked image sensor 11A.

For example, in the stacked image sensor 11A and the stacked image sensor 11B, a structure using through-silicon via (TSV), a structure using Cu—Cu bonding, or the like can be adopted for electrical and mechanical connection between the respective substrates.

### Configuration Example of Electronic Device

The above-described image sensor 11 may be applied to various electronic devices such as an imaging system such as a digital still camera and a digital video camera, a mobile phone having an imaging function, or another device having an imaging function, for example.

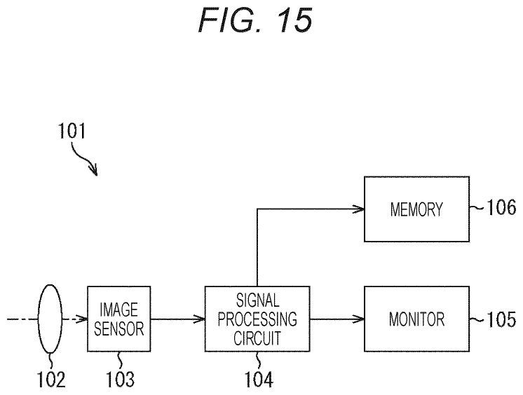

FIG. 15 is a block diagram illustrating a configuration example of an image sensor mounted on an electronic device.

As illustrated in FIG. 15, an image sensor 101 includes an optical system 102, an image sensor 103, a signal processing circuit 104, a monitor 105, and a memory 106, and can capture a still image and a moving image.

The optical system 102 includes one or a plurality of lenses, guides image light (incident light) from a subject to the image sensor 103, and forms an image on a light-receiving surface (sensor unit) of the image sensor 103.

As the image sensor 103, the image sensor 11 described above is applied. Electrons are accumulated in the image sensor 103 for a certain period in accordance with the image formed on the light-receiving surface through the optical system 102. Then, a signal corresponding to the electrons accumulated in the image sensor 103 is supplied to the signal processing circuit 104.

The signal processing circuit 104 performs various types of signal processing on a pixel signal output from the image sensor 103. An image (image data) obtained by the signal processing applied by the signal processing circuit 104 is supplied to the monitor 105 to be displayed or supplied to the memory 106 to be stored (recorded).

In the image sensor 101 configured as described above, for example, an image can be captured at a higher speed by applying the above-described image sensor 11.

### Use Examples of Image Sensor

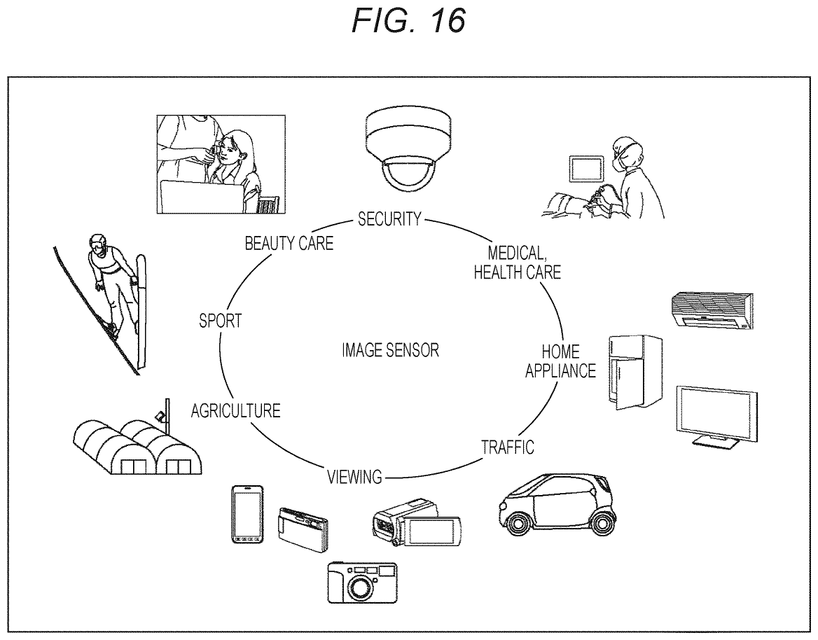

FIG. 16 is a diagram illustrating a use example of the above-mentioned image sensor (image sensor).

The image sensor described above can be used in various cases for sensing light such as visible light, infrared light, ultraviolet light, and X-ray as described below, for example.
A device that captures an image to be used for viewing, such as a digital camera and a portable device with a camera function
A device for traffic purpose such as an in-vehicle sensor which takes images of the front, rear, surroundings, interior and the like of an automobile, a surveillance camera for monitoring traveling vehicles and roads, and a ranging sensor which measures a distance between vehicles and the like for safe driving such as automatic stop, recognition of a driver's condition and the like
A device for home appliance such as a television, a refrigerator, and an air conditioner that images a user's gesture and performs device operation according to the gesture
A device for medical and health care use such as an endoscope and a device that performs angiography by receiving infrared light
A device for security use such as a security monitoring camera and an individual authentication camera
A device used for beauty care, such as a skin measuring instrument for photographing skin, and a microscope for photographing the scalp
A device used for sport, such as an action camera or a wearable camera for sports applications or the like
A device used for agriculture, such as a camera for monitoring a condition of a field or crop

### Example of Configuration Combinations

Note that the present technology may also have the following configurations.

(1)

A signal processing device including:
a product-sum operation processing unit that includes first arithmetic units of a number corresponding to the number of channels, and performs product-sum operation processing of an input pixel value, which is pixel data of an input image, and a filter coefficient in each of the first arithmetic units to acquire product-sum operation results corresponding to the number of channels; and
a convolution operation processing unit including second arithmetic units of a number corresponding to the number of filters, and performing convolution operation processing of acquiring convolution layer output pixel values corresponding to the number of filters by performing convolution operation processing using the product-sum operation result in each of the second arithmetic units and outputting the convolution layer output pixel values as encoded pixel data.
   (2)

The signal processing device according to the above (1), in which
each of the second arithmetic units comprises the product-sum operation processing unit.
   (3)

The signal processing device according to the above (1) or (2), in which
the first arithmetic unit includes:
a data buffer that sequentially stores the input pixel value having a size according to a filter size;
a filter buffer that sequentially stores a filter coefficient having a size according to the filter size;
a first multiplier that multiplies the input pixel value stored in the data buffer by the filter coefficient stored in the filter buffer to obtain a predetermined number of multiplication values corresponding to the filter size; and
a first adder that obtains the product-sum operation result by adding a predetermined number of the multiplication values obtained by the first multiplier.
   (4)

The signal processing device according to any one of the above (1) to (3), in which
the second arithmetic unit further includes:
a second adder that obtains a convolution value by adding each of the product-sum operation results corresponding to the number of channels output from the product-sum operation processing unit and adding a predetermined bias value; and a second multiplier that obtains the product-sum operation result by inputting the convolution value to a predetermined activation operator.
   (5)

The signal processing device according to any one of the above (1) to (4), further including:
an input buffer that temporarily stores the input pixel value input to the convolution operation processing unit, in which
the input pixel value corresponding to the number of filter coefficients is transferred from a storage unit that stores the input image to the input buffer.
   (6)

The signal processing device according to any one of the above (1) to (4), further including:
an input buffer that temporarily stores the input pixel values input to the convolution operation processing unit, wherein
the input pixel value is transferred from a storage unit that stores the input image to the input buffer for each of a plurality of tiles into which the input image is divided.
   (7)

A signal processing method causing
a signal processing device including a product-sum operation processing unit including first arithmetic units of a number corresponding to the number of channels and a convolution operation processing unit including second arithmetic units of a number corresponding to the number of filters to perform the steps of:
acquiring product-sum operation results corresponding to the number of channels by performing a product-sum operation processing of an input pixel value, which is pixel data of an input image, and a filter coefficient in each of the first arithmetic units; and
performing convolution operation processing of acquiring convolution layer output pixel values corresponding to the number of filters by performing convolution operation processing using the product-sum operation result in each of the second arithmetic units, and outputting the convolution layer output pixel values as encoded pixel data.
   (8)

A solid-state image sensor comprising a signal processing unit including:
a product-sum operation processing unit that includes first arithmetic units of a number corresponding to the number of channels, and performs product-sum operation processing of an input pixel value, which is pixel data of an input image, and a filter coefficient in each of the first arithmetic units to acquire product-sum operation results corresponding to the number of channels; and
a convolution operation processing unit including second arithmetic units of a number corresponding to the number of filters, and performing convolution operation processing of acquiring convolution layer output pixel values corresponding to the number of filters by performing convolution operation processing using the product-sum operation result in each of the second arithmetic units and outputting the convolution layer output pixel values as encoded pixel data.
   (9)

The solid-state image sensor according to the above (8), in which
a sensor substrate provided with an imaging unit in which a plurality of pixels is arranged in a matrix on a sensor surface and a logic substrate provided with the signal processing unit are stacked as a stacked structure.
   (10)

The solid-state image sensor according to the above (9), in which
a memory substrate provided with a storage unit that stores pixel data based on a pixel signal output from the imaging unit is further stacked as the stacked structure.

Note that, the present embodiment is not limited to the embodiments described above, and various alterations can be made without departing from the gist of the present disclosure. Furthermore, the effects described herein are merely examples and are not limited, and other effects may be provided.

### REFERENCE SIGNS LIST

11 Image sensor
21 Imaging unit
22 Imaging processing unit
23 Storage unit
24 DMA processing unit
25 Encoding unit
26 Transmission unit
27 Reception unit
28 Control unit
31 Line memory
32 Frame memory
33 Network data memory
41 Input data buffer
42 Convolution operation processing unit
43 Output data buffer
44 Arithmetic unit
51 Product-sum operation processing unit
52 Adder
53 Multiplier
54 Arithmetic unit
61 Data buffer
62 Shift register
63 Filter buffer
64 Multiplier
65 Adder
71 Sensor substrate
72 Logic substrate
73 Memory substrate

1. A signal processing device comprising:
a product-sum operation processing unit that includes first arithmetic units of a number corresponding to the number of channels, and performs product-sum operation processing of an input pixel value, which is pixel data of an input image, and a filter coefficient in each of the first arithmetic units to acquire product-sum operation results corresponding to the number of channels; and
a convolution operation processing unit including second arithmetic units of a number corresponding to the number of filters, and performing convolution operation processing of acquiring convolution layer output pixel values corresponding to the number of filters by performing convolution operation processing using the product-sum operation result in each of the second arithmetic units, and outputting the convolution layer output pixel values as encoded pixel data.

2. The signal processing device according to claim 1, wherein
each of the second arithmetic units comprises the product-sum operation processing unit.

3. The signal processing device according to claim 1, wherein
the first arithmetic unit comprises:
a data buffer that sequentially stores the input pixel value having a size according to a filter size;
a filter buffer that sequentially stores a filter coefficient having a size according to the filter size;
a first multiplier that multiplies the input pixel value stored in the data buffer by the filter coefficient stored in the filter buffer to obtain a predetermined number of multiplication values corresponding to the filter size; and
a first adder that obtains the product-sum operation result by adding a predetermined number of the multiplication values obtained by the first multiplier.

4. The signal processing device according to claim 1, wherein
the second arithmetic unit further comprises:
a second adder that obtains a convolution value by adding each of the product-sum operation results corresponding to the number of channels output from the product-sum operation processing unit and adding a predetermined bias value; and a second multiplier that obtains the product-sum operation result by inputting the convolution value to a predetermined activation operator.

5. The signal processing device according to claim 1, further comprising:
an input buffer that temporarily stores the input pixel value input to the convolution operation processing unit, wherein
the input pixel value corresponding to the number of filter coefficients is transferred from a storage unit that stores the input image to the input buffer.

6. The signal processing device according to claim 1, further comprising:
an input buffer that temporarily stores the input pixel values input to the convolution operation processing unit, wherein
the input pixel value is transferred from a storage unit that stores the input image to the input buffer for each of a plurality of tiles into which the input image is divided.

7. A signal processing method causing
a signal processing device including a product-sum operation processing unit including first arithmetic units of a number corresponding to the number of channels and a convolution operation processing unit including second arithmetic units of a number corresponding to the number of filters to perform the steps of:
acquiring product-sum operation results corresponding to the number of channels by performing a product-sum operation processing of an input pixel value, which is pixel data of an input image, and a filter coefficient in each of the first arithmetic units; and
performing convolution operation processing of acquiring convolution layer output pixel values corresponding to the number of filters by performing convolution operation processing using the product-sum operation result in each of the second arithmetic units, and outputting the convolution layer output pixel values as encoded pixel data.

8. A solid-state image sensor comprising a signal processing unit including:
a product-sum operation processing unit that includes first arithmetic units of a number corresponding to the number of channels, and performs product-sum operation processing of an input pixel value, which is pixel data of an input image, and a filter coefficient in each of the first arithmetic units to acquire product-sum operation results corresponding to the number of channels; and
a convolution operation processing unit including second arithmetic units of a number corresponding to the number of filters, and performing convolution operation processing of acquiring convolution layer output pixel values corresponding to the number of filters by performing convolution operation processing using the product-sum operation result in each of the second arithmetic units, and outputting the convolution layer output pixel values as encoded pixel data.

9. The solid-state image sensor according to claim 8, wherein
a sensor substrate provided with an imaging unit in which a plurality of pixels is arranged in a matrix on a sensor surface and a logic substrate provided with the signal processing unit are stacked as a stacked structure.

10. The solid-state image sensor according to claim 9, wherein
a memory substrate provided with a storage unit that stores pixel data based on a pixel signal output from the imaging unit is further stacked as the stacked structure.
